(19) United States
(12) Patent Application Publication
(10) Pub. No.: US 2007/0215601 A1
(43) Pub. Date: Sep. 20, 2007

(54) Combined sensor and heating element

(76) Inventor: Thorsten Frank, Heidelberg (DE)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/582,104

(22) PCT Filed: Oct. 23, 2004
(86) PCT No.: PCT/EP04/12011

§ 371 Date: Jun. 8, 2006

(30) Foreign Application Priority Data
Dec. 12, 2003 (DE) 103 58 793.4

(51) Int. Cl. H05B 1/02; B60L 1/02

(52) U.S. Cl. 219/497; 219/202; 219/490

(57) ABSTRACT

The invention relates to a combined sensor and heating element (1) which is suitable, in particular, for the seat of a motor vehicle. Said element comprises a sensor mat provided with a heating arrangement. According to the invention, the sensor mat is embodied as a flexible conductor path comprising a carrier film (2) and conductor paths (4) of a sensor arrangement, which are arranged on the surface of the carrier film (2). The heating conductors (3) of the heating conductor arrangement are arranged on the same carrier film surface between and/or near to the conductor paths (4) of the sensor arrangement.

### TECHNICAL AREA

The present invention relates to a combined sensor and heating element, in particular for the seat of a motor vehicle, including a sensor mat having a heating conductor system.

### BACKGROUND INFORMATION

A combined sensor and heating element of the type cited above is known from LU 90 583 A1. The known combined sensor and heating element relates to the combination of a seat heater and seat-occupant detection sensors, which are typically used for the purpose of preventing triggering of the airbag assigned to a specific vehicle seat in the event of an accident if the corresponding vehicle seat is not occupied. The seat-occupant detection sensors described in the document include a sensor mat having multiple pressure-sensitive areas, which are connected to one another by flexible connection strips. According to the document, a sensor mat is positioned on the vehicle seat in such a way that the pressure-sensitive areas are distributed over the seat surface of the vehicle seat.

A seat heater of a motor vehicle generally includes a heating mat having two nonwoven material layers and a heating layer embedded between the two nonwoven material layers. Such a heating mat is also situated on the seat surface of the vehicle seat in such a way that the heating conductor extends essentially over the entire seat surface of the vehicle seat.

In vehicle seats which are equipped with both a seat-occupant sensor and a seat heater, the sensor mat and the heating mat are assembled to form a combined sensor and heating element before being installed in the seat. The manufacturing of such a combined sensor and heating element is comparatively complex, however, since the two functional elements must first be manufactured separately and then fixed to one another.

LU 90 583 A1 thus suggests that the heating conductors not be embedded separately in a manipulatable nonwoven laminate, which must subsequently be fixed on the sensor mat, but rather that the heating conductors be attached directly to the flexible connection strips of the sensor mat. The manufacture of such a combined sensor and heating element should require significantly fewer individual steps than the manufacture of typical combination elements. In addition, the material expenditure for such a combined sensor and heating element should be significantly lower than for typical functional elements.

### DESCRIPTION OF THE INVENTION

The object of the present invention is to refine a combined sensor and heating element of the known type in such way that the manufacture is simplified still further and the material expenditure is reduced still further. This object is achieved by a combined sensor and heating element having all the features of claim 1. A vehicle seat which includes a combined sensor and heating element according to the present invention is described in claim 18. Claims 21 and 22 relate to methods for manufacturing a sensor and heating element according to the present invention. Preferred embodiments of the present invention are described in the subclaims.

In a combined sensor and heating element of the present invention which is suitable in particular for the seat of a motor vehicle and includes a sensor mat having a heating conductor system, the sensor mat is implemented as a flexible printed conductor film which includes a carrier film and printed conductors of a sensor system situated on the surface of the carrier film, and the heating conductors of the heating conductor system are situated on the same carrier film surface between and/or adjacent to the printed conductors of the sensor system.

The combined sensor and heating element of the present invention distinguishes itself from the known combination element by a significantly simplified construction. The two functional elements, sensor mat and heater, are not situated above or below one another in different planes as in the known combination element, but rather in the same plane, a plane as defined in the present invention not necessarily understood to be “flat.” The same plane is to be understood within the scope of the present invention in such a way that the printed conductors of both functional elements are applied to the same surface of a support film, which may possibly also be curved (during installation in a vehicle seat, for example). Preferably, they are situated at a distance from one another, so that the occurrence of an electrical contact is reliably avoided even without further measures. The present invention is not restricted to this embodiment, however. If sufficient insulation is ensured at the intersection points, intersections of the printed conductors are also conceivable. Such insulation may be implemented by applying a coating lacquer or an insulating film, for example. It is obvious that the wiring of the combined sensor and heating element to the analysis and/or power electronics, for example, may also be integrated in the printed conductor system on the carrier film surface.

As a result of the simplified construction of a combined sensor and heating element (combination element) according to the present invention having a significantly reduced number of components in relation to the related art, the manufacturing method is also significantly simplified and further material savings are achieved. Because the number of process steps during manufacturing is able to be reduced, the risk that process errors will occur also decreases. Overall, this results in an improvement in quality. The combination element according to the present invention may therefore be manufactured simply and cost-effectively. In particular, as will be described in the following, known processes may be used for manufacturing a combination element according to the present invention.

In a preferred embodiment of the present invention, the sensor system includes seat-occupant detection sensors. Seat-occupant sensors are to be understood in the broadest sense as all sensor types which are capable of generating a signal when a seat is occupied by a person. A known group of seat-occupant sensors is pressure sensors, for example. Pressure sensors are known per se and have been described many times in the literature. Their mode of operation is essentially based on the change of electrical properties due to the effect of a weight exerted on the sensor. This may be the production of an electrically conductive connection due to pressure exerted on the sensor, or also the change of an electrical capacitance when a distance is changed by pressure being exerted. Within the scope of the present invention, both simple seat-occupant detection sensors, which may solely differentiate between the states “occupied” and “unoccupied,” and also sensors which are capable of recording and/or analyzing a pressure profile may be used.

In a further preferred embodiment of the present invention, the output signal of the seat-occupant detection sensor is used to switch and/or control the heating conductor system. This embodiment is suitable in particular for implementing a seat heater having a variable heating area, in which the heating area is divided into different zones, which may be switched and controlled independently of one another. Thus, for example, only those areas which are in direct bodily contact with the seated person may be heated, while the areas which are not contacted are not heated. Since there are great differences in regard to the bodily dimensions of people, the body contact surfaces are also of different sizes, so that the heating areas required for effective heating differ for different people. The present invention thus allows an intelligent seat heater, in which only the actually required areas are heated, which results in significant energy savings.

In addition to the simple variation of simply turning on/off when areas of a seat are occupied or unoccupied, respectively, it is also possible within the scope of the present invention to set predefined heat profiles, which increase the comfort of a person located on the seat in that specific body parts are heated strongly, weakly, or not all, possibly changing chronologically.

The output signal of the seat-occupant detection sensors may additionally be used for airbag control, as is known from the related art.

The present invention also allows the simple integration of switches which may be operated by a person located in the vehicle. These may be provided laterally in the form of an operating panel on the vehicle seat, for example. All seat-occupant detection sensors, for example, which have a switch function in addition to the seat-occupant detection function, are suitable as switches. These may be easily applied to the carrier film in one work step with the sensors.

Preferably, film switches, such as dome switches, are used as the pressure sensors. Film switches are known per se. They typically include an electrode pair situated on a carrier film, via which a contact surface, which is implemented as a dome and may be made of plastic, in particular polyester, or also metal, for example, is situated. The contact surface and/or the dome may be connected to one of the two electrodes in an electrically conductive manner. For contact surfaces or domes made of nonconductive material, such as polyester, electrically conductive connection elements which produce the electrical contact when actuated by the contact surface or the dome may also be provided in the area of the contact surface or the dome. Actuation occurs via the application of pressure. The contact surface or the dome or the switch on the contact surface or on the dome curves inward and produces the contact to the second electrode and/or between two electrodes to be connected. Film switches are thus distinguished by a relatively simple construction and are also cost-effective to manufacture. However, “flat switches,” as described in LU 90 583 A1, may also be used.

Instead of the seat-occupant detection sensors, a sensor system including temperature sensors may also be provided. A combination made of seat-occupant detection sensors and temperature sensors is also possible.

The printed conductors are preferably made of copper or also of silver or carbon, produced through conductive paste printing. The same material is advantageously used for the heating conductor system and the sensor system. It is also possible, however, for the printed conductors for the heating conductor system and the sensor system to be made of different materials. The use of the same material for both functional elements has the advantage of simpler manufacturability.

The heating conductor system and the sensor system on the carrier film are expediently covered using a protective layer. The protective layer may include both a plastic film and also, if a textile design of the surface is desired, for example, a nonwoven material layer. The use of a nonwoven material layer has the advantage that a desired rigidity may be achieved in addition to the protective effect. However, a combination of plastic and nonwoven materials or an extended multilayered construction may also be provided.

The carrier film typically includes a flexible plastic film, made of PI (polyamide), PEN (polyethylene naphthalate), or PET (polyethylene terephthalate), for example.

The construction of a combined sensor and heating element is further simplified significantly if the electrical terminals of the heating conductor system and the sensor system are situated on the carrier film in such a way that they are connectable to the same terminal plugs. In particular, it is also advantageous if the heating conductor system and the sensor system are connectable to shared analysis and power supply electronics.

In a further preferred embodiment of the present invention, switches, diodes, and/or electronic components may be integrated in the combined sensor and heating element.

A combined sensor and heating element according to the present invention is suitable in particular for use in a seat for a motor vehicle, only one heating zone being able to be provided in the simplest case. An intelligent seat heater having a variable heating area requires that the heating conductors and the assigned sensors be situated on the seat surface and/or the backrest of the vehicle seat in such a way that they form heating zones which may be switched and controlled independently of one another. Especially efficient heating of the vehicle seat is achieved if the heating zones are tailored to the contour of a human body located on the seat.

The combined sensor and heating element according to the present invention is, however, not restricted to the above application. In particular, the possibility of division into zones which may be switched and controlled independently of one another and may be easily geometrically tailored to the particular application opens up manifold possible uses.

A combined sensor and heating element according to the present invention is preferably manufactured using the method described in the following.

In a first method step, a coating made of a printed conductor material is applied to a carrier film, such as a flexible plastic film. The printed conductor material, which is particularly preferably made of copper, is preferably laminated onto the carrier. Subsequently, an etch resist coating is printed on the printed conductor coating. This step may possibly also be preceded by the cleaning and initial etching of the printed conductor coating. The etch resist is applied in a pattern which corresponds to the desired conductor layout. According to a preferred embodiment of the present invention, the conductor layout may also include the wiring of the combined sensor and heating element to the outside, for example, to the analysis or power supply electronics. In the etching process which now follows, the printed conductor coating is etched away down to the flexible carrier film in the areas not covered by the etch resist. The etching process is preferably performed in acid solution. Hydrochloric acid (HCl), hydrogen peroxide (H₂O₂), or a copper chloride (CuCl₂) solution is suitable for this purpose, for example. After the removal of the resist by flushing with an alkaline solution, i.e., stripping, the finished printed conductor structure is available on the carrier film. In a further method step, a protective layer, made of plastic film and/or a nonwoven material layer, may finally be applied, preferably laminated on.

A further method for manufacturing the printed conductor structure is conductive paste printing, e.g., silver or carbon printing. If such a method is used, the etching and stripping process is dispensed with. However, a coating and etching method, as described above, and a conductive paste printing method may also be used in combination.

The methods described are known and tested methods for manufacturing printed circuits. These known methods allow the manufacture of a combined sensor and heating element according to the present invention in a particularly simple and cost-effective way. In particular, manufacturing the printed conductors for the heating conductor system and the sensor system in the same process step results in a significant method simplification in relation to the known combination element.

### BRIEF DESCRIPTION OF THE DRAWING

In the following, the present invention is described in greater detail on the basis of the figures.

FIG. 1 shows a preferred embodiment of a sensor and heating element according to the present invention;

FIG. 2 shows a further preferred embodiment of a sensor and heating element according to the present invention having four heating zones, which may be switched and controlled independently of one another;

FIG. 3 shows a sequence diagram of the most important process steps of a preferred method for manufacturing a sensor and heating element according to the present invention.

### DETAILED DESCRIPTION OF THE EMBODIMENTS

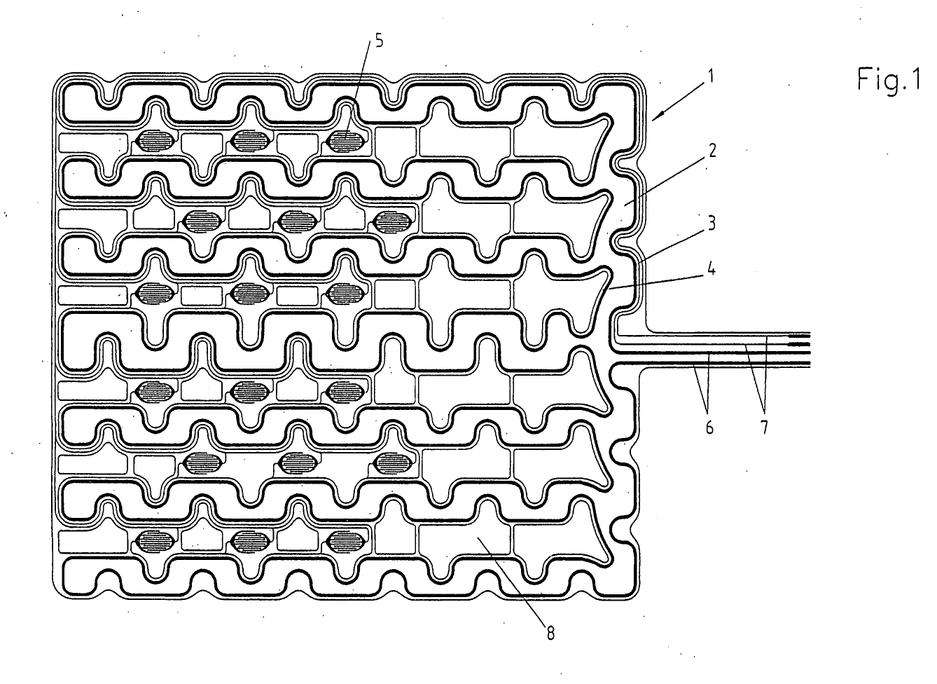

FIG. 1 shows a combined sensor and heating element 1 according to the present invention. This combined sensor and heating element 1 has a flexible carrier film 2, to which a heating conductor system and a sensor printed conductor system are applied. Both printed conductors 3 of the heating conductor system and also printed conductors 4 of the sensor system completely cover the entire area of combined sensor and heating element 1. For this purpose, they are guided in waves and/or meandering over the surface. However, the present invention is not restricted to this geometric arrangement of printed conductors 3, 4. Any geometric arrangement of printed conductors 3, 4 which ensures coverage of large areas is conceivable. Printed conductors 3 do not have any branches between their terminal ends 6 in FIG. 1, so that targeted current conducting results when electrical power is applied.

Furthermore, electrode systems 5, which are also distributed over the surface of combined sensor and heating element 1, are shown as a component of a pressure-sensitive sensor, such as a dome switch. In the exemplary embodiment shown, electrode pairs 5 are implemented as structures engaged in one another like combs. These comb-like structures form the base of a dome switch without restriction of the generality. The comb-like structure ensures that when the dome located over the structure is pressed down, an electrical contact is always produced.

Without restriction of the generality, electrical terminals 6, 7 for printed conductors 3 of the heating conductor system and printed conductors 4 of the sensor system are guided out of carrier film 2 at the same point of the combined sensor and heating element according to the present invention, so that they are connectable to a shared connection plug.

In the areas between printed conductors 3, 4 not occupied by sensors 5, the carrier film material may be stamped out in predefined areas 8, as shown in the figure. This has the advantage that the flexibility is increased, as is the ductility. A further advantage is that seat climate control is possible in the stamped-out areas.

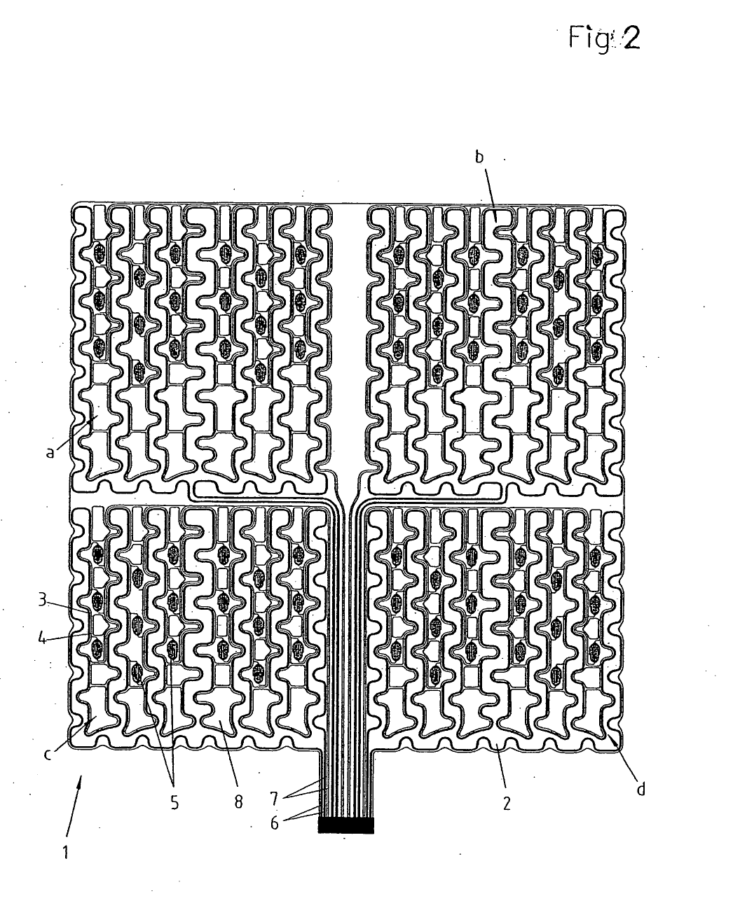

For better clarity, the combined sensor and heating element according to the present invention shown in FIG. 1 is distinguished by a single heating zone, which may be switched and controlled by sensor system 5. Four such heating zones a, b, c, d, which may be switched and controlled independently of one another, are combined into one variable heating area in FIG. 2 as an example and without restriction of the generality. It is clear that an intelligent seat heater having a variable heating area may be implemented by simply joining multiple heating zones together, for example, the outer contour being able to be selected freely.

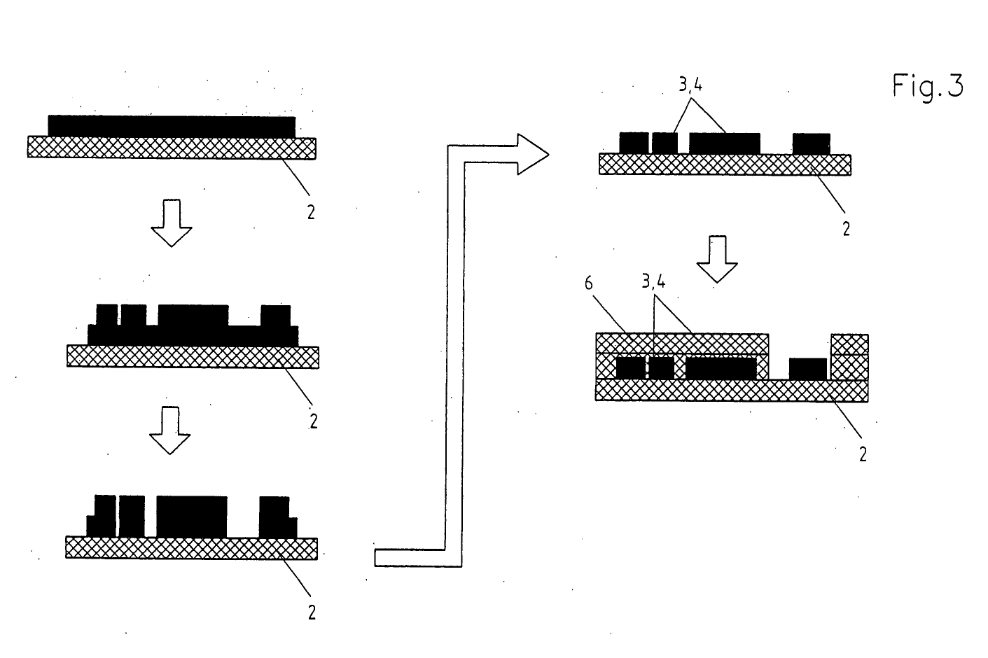

FIG. 3 shows the most important steps of a preferred method for manufacturing a combined sensor and heating element 1 according to the present invention. In a first method step, a flexible carrier film 2, made of PI (polyimide), PET (polyethylene terephthalate), or PEN (polyethylene naphthalate), for example, is covered by a printed conductor material, such as a copper film. The cover film is preferably laminated onto the flexible carrier material.

Subsequently, the thus manufactured base material is cleaned and initially etched. In a next step, the etch resist is applied in a pattern corresponding to the desired conductor layout. In the following etching process, the printed conductor material is etched away down to the carrier film using an acid solution in the areas not covered by the etch resist. After the etch resist is removed by stripping, i.e., by flushing away using an alkaline solution, the finished conductor layout made of the printed conductor material remains on carrier film 2. A protective layer 6, made of a plastic film or a nonwoven material layer, for example, may be applied, preferably laminated on, to protect the printed conductor structure.

1-32. (canceled)

33. A combined sensor and heating element comprising:
a sensor mat including a heating conductor system with heating conductors, a carrier film having a surface, and a sensor system having sensor printed conductors on the surface, the heating conductors being situated on the surface between and/or neighboring the sensor printed conductors,
the sensor mat defining a flexible printed conductor film.

34. The combined sensor and heating element as recited in claim 33 wherein the sensor system includes seat-occupant detection sensors or temperature sensors.

35. The combined sensor and heating element as recited in claim 34 wherein the heating conductor system may be switched or controlled using the seat-occupant detection sensors.

36. The combined sensor and heating element as recited in claim 34 wherein a signal of the seat-occupant sensors is usable for airbag control.

37. The combined sensor and heating element as recited in claim 33 wherein the sensor system or seat-occupant detection sensors include pressure sensors.

38. The combined sensor and heating element as recited in claim 37 wherein the pressure sensors include film switches.

39. The combined sensor and heating element as recited in claim 33 wherein the heating conductors include printed conductors made of the same material as the sensor printed conductors.

40. The combined sensor and heating element as recited in claim 39 wherein the same material is copper or conductive paste.

41. The combined sensor and heating element as recited in claim 33 further comprising a protective layer over the heating conductor system and the sensor system.

42. The combined sensor and heating element as recited in claim 41 wherein the protective layer includes a plastic film or a nonwoven material layer.

43. The combined sensor and heating element as recited in claim 33 wherein the carrier film includes a flexible plastic film.

44. The combined sensor and heating element as recited in claim 43 wherein the plastic film is made of PI (polyimide), PET (polyethylene terephthalate), or PEN (polyethylene naphthalate).

45. The combined sensor and heating element as recited in claim 33 wherein electrical terminals of the heating conductor and the sensor system are situated on the carrier film so the heating conductor and the sensor system are connectable to a same connection plug.

46. The combined sensor and heating element as recited in claim 33 wherein the heating conductor system and the sensor system are connectable to shared analysis and power supply electronics.

47. The combined sensor and heating element as recited in claim 33 wherein the sensor mat includes wiring to analysis and power supply electronics.

48. The combined sensor and heating element as recited in claim 33 wherein the sensor mat includes integrated diodes, switches, or other electronic components.

49. The combined sensor and heating element as recited in claim 33 wherein the sensor mat is divided into zones, each zone being switched, controlled, or regulated independently.

50. A vehicle seat comprising at least one combined sensor and heating element as recited in claim 33.

51. The vehicle seat as recited in claim 50 wherein the seat has a surface or backrest with heating zones, the heating zones being switched, controlled or regulated independently.

52. The vehicle seat as recited in claim 50 wherein the heating zones are tailored to a contour of a human body located on the seat.

53. A method for manufacturing a combined sensor and heating element as recited in claim 33 comprising the step of:
applying at least partially the sensor printed conductors to the carrier film using a conductive paste printing method.

54. The method as recited in claim 53 wherein a conductor layout includes wiring of a combined sensor and heating element to an analysis or power supply electronics.

55. The method as recited in claim 53 wherein the sensor printed conductors are laminated onto the carrier.

56. A method as recited in claim 53 further comprising the step of applying a protective layer to the flexible printed conductor film.

57. The method as recited in claim 56 wherein the protective layer is laminated on.

58. The method as recited in claim 56 wherein the protective layer is made of a plastic film or a nonwoven material.

59. The method as recited in claim 53 wherein the carrier film is a plastic film made of PI (polyimide), PET (polyethylene terephthalate), or PEN (polyethylene naphthalate).

60. A method for manufacturing a combined sensor and heating element as recited in claim 33 comprising the steps of:
applying a coating made of a printed conductor material to the carrier film,
applying an etch resist coating, in a pattern corresponding to a desired conductor layout, to the coating made of the printed conductor material,
etching away the coating made of the printed conductor material in areas not having the etch resist coating; and
removing the etch resist coating, the remaining printed conductor material defining at least partially the sensor printed conductor material.

61. The method as recited in claim 60 wherein the conductor layout includes wiring of the combined sensor and heating element to the analysis or power supply electronics.

62. The method as recited in claim 60 wherein the printed conductor material is laminated onto the carrier.

63. The method as recited in claim 60 wherein the printed conductor material is copper.

64. The method as recited in claim 63 further comprising the steps of:
cleaning the copper coating; and
etching initially before applying the etch resist coating.

65. The method as recited in claim 60 wherein the step of applying the etch resist coating includes printing on the etch resist coating.

66. The method as recited in claim 60 wherein the step of removing the etch resist includes flushing using an alkaline solution.

67. The method as recited in claim 60 further comprising the step of applying a protective layer to a finished printed conductor structure.

68. The method as recited in claim 60 wherein the protective layer is laminated on.

69. The method as recited in claim 60 wherein the protective layer is made of a plastic film or a nonwoven material.

70. The method as recited in claim 60 wherein the carrier film is a plastic film made of PI (polyimide), PET (polyethylene terephthalate), or PEN (polyethylene naphthalate).
